(19) United States
(12) Patent Application Publication
(10) Pub. No.: US 2018/0068355 A1
(43) Pub. Date: Mar. 8, 2018

(54) RENTAL VEHICLE FLEET MANAGEMENT SYSTEM

(71) Applicant: CMT Group, LLC, Cleveland Heights, OH (US)

(72) Inventors: Keith GARRY, Richmond Heights, OH (US); Kenneth MINARDO, Mayfield Heights, OH (US); Trevor GILE, Chagrin Falls, OH (US)

(21) Appl. No.: 15/698,234

(22) Filed: Sep. 7, 2017

Related U.S. Application Data
(60) Provisional application No. 62/384,528, filed on Sep. 7, 2016.

(51) Int. Cl. G06Q 30/02; G06Q 30/06; G07C 5/08; G06Q 10/06

(52) U.S. Cl. CPC G06Q 30/0278; G06Q 30/0645; G06Q 10/06; G07C 5/0808; G06Q 30/06

(57) ABSTRACT

A system for analyzing vehicle data to determine a time to sell a rental vehicle includes: a data acquisition device configured to interface with a vehicle and to collect one or more data parameters associated with the vehicle; and a data analysis device comprising a processor, a communication interface for interfacing with the data acquisition device, a computer tangible storage device, and program instructions stored on the storage device for execution by the processor.

### CROSS-REFERENCE TO RELATED APPLICATION

This application claims priority from U.S. patent application Ser. No. 62/384,528 filed on Sep. 7, 2016, which is incorporated by reference herein in its entirety.

### TECHNICAL FIELD

Embodiments of the subject matter disclosed herein relate to vehicle rentals and the management of a vehicle fleet.

### DISCUSSION OF ART

Conventionally, rental car facilities utilize employees to facilitate a car rental transaction. The employee receives and records the customer's information and any vehicle request, and checks out a vehicle to the customer. Upon returning the vehicle, the employee checks in the vehicle and records minimal data such as miles driven and fuel, consumed. Additional data that may be beneficial to the owner of the rental vehicle may difficult or time consuming to obtain, however.

### SUMMARY

A system for analyzing vehicle data to determine a time to sell a rental vehicle includes a data acquisition device configured to interface with a vehicle and to collect one or more data parameters associated with the vehicle. The system further includes a data analysis device comprising a processor, a communication interface for interfacing with the data acquisition device, a computer tangible storage device, and program instructions stored on the storage device for execution by the processor. The program instructions include first program instructions for analyzing the collected data parameters associated with the vehicle to determine a current market. value of the vehicle. The program instructions further include second program instructions for extrapolating the collected data parameters to predict a depreciated value of the vehicle at a future time. The program instructions further include third program instructions for calculating a value for predicted benefit resulting from continuing to loan the vehicle until the future time. The program instructions further include fourth program instructions for determining when and for what amount to sell the rental vehicle, based on the determined current market value of the vehicle, the predicted market value of the vehicle, and the calculated predicted profits from continuing to rent the vehicle.

A method for analyzing vehicle data to determine a time to sell a rental vehicle includes the step of a computer collecting one or more data parameters associated with the vehicle. The method further includes the step of the computer analyzing the collected data parameters associated with the vehicle to determine a current market value of the vehicle. The method further includes the step of the computer extrapolating the collected data parameters to predict a value of the vehicle at a future time. The method further includes the step of the computer calculating a value for predicted profits generated from continuing to rent the vehicle until the future time. The method further includes the step of the computer determining when and for what amount to sell the rental vehicle, based on the determined current market value of the vehicle, the predicted market value of the vehicle, and the calculated predicted profits from continuing to rent the vehicle.

A computer program product for analyzing vehicle data to determine a time to sell a rental vehicle, the computer program product includes one or more computer-readable tangible storage devices, and program instructions stored on at least one of the one or more storage devices. The program instructions include first program instructions for collecting one or more data. parameters associated with the vehicle. The program instructions further include second program instructions for analyzing the collected data parameters associated with the vehicle to determine a current market value of the vehicle. The program instructions further include third program instructions for extrapolating the collected data parameters to predict a value of the vehicle at a future time. The program instructions further include fourth program instructions for calculating a value for predicted profits generated from continuing to rent the vehicle until the future time. The program instructions further include fifth program instructions for determining when and for What amount to sell the rental vehicle, based on the determined current market value of the vehicle, the predicted market value of the vehicle, and the calculated predicted profits from continuing to rent the vehicle.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of a system for tracking and management of rental vehicles;

FIG. 2 is an illustration of an embodiment of a system that is configured to manage a rental fleet with a rental recorder coupled to a guest interface and data acquisition devices;

FIG. 3 is a block diagram of an exemplary, non-limiting rental recorder application according to one or more aspects;

FIG. 4 is a schematic block diagram illustrating a suitable operating environment for aspects of the subject disclosure;

FIG. 5 is a schematic block diagram illustrating a suitable environment for delivery of data in accordance with the subject disclosure;

FIG. 6 is a schematic block diagram illustrating illustrates a cloud computing environment in accordance with the subject innovation; and

FIG. 7 is a flow chart illustrating an example method for analyzing vehicle data.

### DETAILED DESCRIPTION

Embodiments of the invention relate to methods and systems that relate to evaluating one or more rental vehicles during rented periods of time to customers in order to provide a rating or value on such rental vehicles that reflects the periods of time the customers used the vehicles and/or how the vehicles were used. In particular, one or more parameters can be tracked via a device in communication with a rental vehicle. During the rental period of time, the one or more parameters can be tracked and evaluated for the rental life of the vehicle. The one or more parameters can be utilized to evaluate fees for a rental customer, a rating or ranking of a rental vehicle upon completion of the rental life, or an adjustment of a sale price or trade-in value of the rental vehicle.

The term “rental vehicle” as used herein can be defined as a vehicle or a device that is rented from an owner of the device or vehicle for a fee, wherein the fee can be determined based on the make/model/type of device or vehicle and a duration of time the vehicle or device is rented or borrowed. Upon return of the vehicle or device, additional fees can be assessed based on not returning the vehicle or device in the same or similar condition as it was rented. In some examples, a fee may not be charged. For instance, a dealership may loan out a rental vehicle to a customer while the customer's vehicle is being serviced. It should be appreciated that a benefit from either renting or loaning out the vehicle may be achieved. For example, when a vehicle is rented, a monetary amount may be received. However, when a vehicle is loaned out, even though no monetary amount may be received, the lender may still benefit by providing good customer service and thereby keeping a customer happy while the customer's vehicle is being serviced.

The term “component” as used herein can be defined as a portion of hardware, a portion of software, or a combination thereof. A portion of hardware can include at least a processor and a portion of memory, wherein the memory includes an instruction to execute.

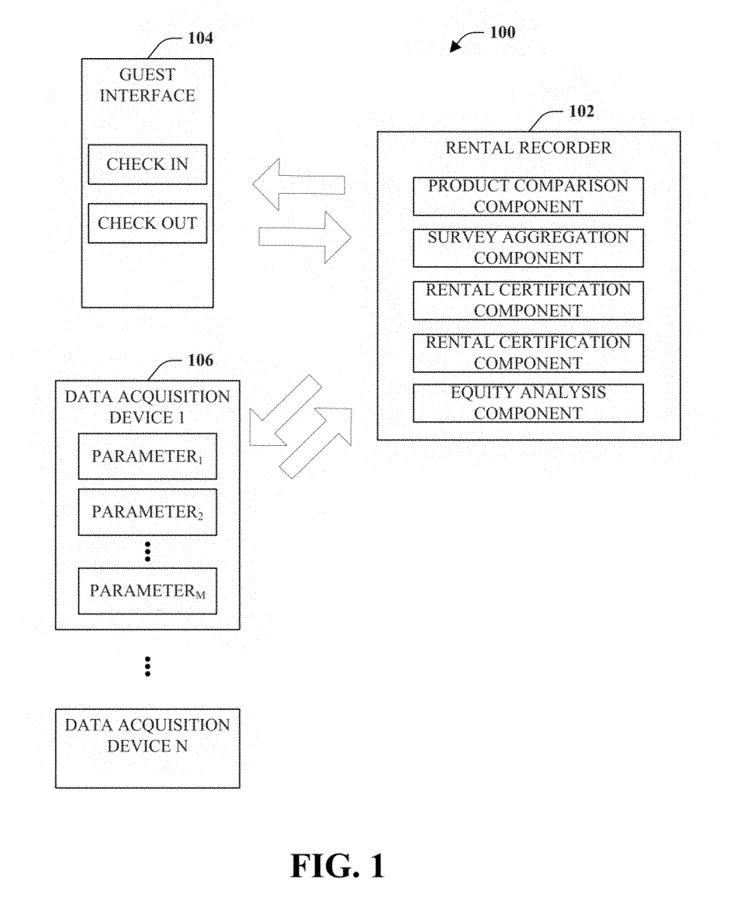

FIG. 1 illustrates a system 100 that is configured to track one or more parameters of a rental vehicle. The system 100 can include a plurality of data acquisition devices 106 in which each data acquisition device 106 can record and/or transmit data from a rental vehicle. In an embodiment, the data acquisition device 106 can be portable and removable or it can be permanently integrated into the vehicle. By way of example and not limitation, the data acquisition device can be plugged into the rental vehicle's on-board diagnostic port or it can be hardwired into the rental vehicle's computer. The data acquisition device 106 can store data locally or it can wirelessly transmit the data in real-time via satellite communications, cellular communications, or any other appropriate wireless communication protocol. In an embodiment, the data acquisition device 106 stores the data locally and also wirelessly transmits the data in real time. It is to be appreciated that there can be any suitable number of data acquisition devices such as data acquisition device 1 to N, where N is a positive integer.

Examples of data points or parameters collected by the data acquisition device 106 can include speed driven, maximum speed driven, average speed driven, road condition, GPS location, rate of acceleration, rate of deceleration, fuel consumption, degrees of turns taken, tire tread temperature, tire tread wear, impact detection on a portion of the front or rear bumper, impact detection on a portion of the body of the vehicle, weight pulled by the vehicle, total weight transported within the vehicle, parameter related to a shock or strut wear, parameter related to a brake pad wear, temperature of a brake pad over a rental period, amount of gear change and frequency, peak volume of an audio system, revolutions per minute for the engine, amount of times starter is used, period of time between use of brake and gas pedal, type of replacement parts (e.g., brand, cost, make, quality, etc.), detection of consumables within the vehicle (e.g., food, cigarette, vaporizing, cigar, drink, etc.), oil level, oil pressure, average oil temperature, oil change frequency, parameter related to oil removed from the rental vehicle, oil peak temperature, type of fluids or fuels used with vehicle, low fuel, check-engine status, or any other error code available via the vehicle's on-board diagnostic system, among others. There can be any suitable number of parameters such as parameter 1 to parameter M, where M is a positive integer.

As illustrated in FIG. 1, certain embodiments can include a rental recorder 102. The rental recorder 102 can exist on a physical server, on a computer, or in the cloud. The rental recorder 102 receives the data transmitted by the data acquisition devices 106. Using this data., the rental recorder 102 can run an equity analysis on an individual rental vehicle. For example, the rental recorder 102 can perform calculations to determine, using the data received from the vehicle's data acquisition device 106 (e.g., parameters or data points), a market value of the rental vehicle if sold, an adjustment to a sale price, and/or a rating or ranking of the rental vehicle based on the evaluation of the parameters. In an embodiment, the rental recorder can compare this value with the calculated value of predicted profits from the continued rental of the vehicle. This information can be used to decide when to sell a used rental vehicle or how much the vehicle should be sold, for example.

The rental recorder 102 can aggregate the data collected for the specific rental vehicle and include this information on a rental certification for that vehicle. This rental certification communicates to a potential buyer the type of driving performed and the conditions that the vehicle was driven in. The rental certification can effectively increase the value of a rental vehicle being sold if the certification contains information showing responsible, or light driving. On the other hand, the rental certification can decrease the value of a rental vehicle being sold if the certification contains information showing severe, or rough driving.

In certain embodiments, the rental recorder 102 stores data regarding the brand or model of products installed on the rental vehicles. For example, the rental recorder 102 can keep track of brands or models of tires, oil, or any auto part used on each rental vehicle. This information can be used along with vehicle performance data to analyze and compare the performance of different brands and models of equipment or auto parts.

In some embodiments, the rental recorder 102 communicates with a guest interface 104 (also referred to as a guest component). The guest interface 104 allows a customer to check a car out or check a car in with no, or minimal, employee interaction. For example, the guest interface 104 can be a computer, a smartphone, or a tablet. Upon checking out a rental vehicle, the customer can input personal information such as their name, e-mail address, phone number, or address. The customer can also be prompted to input a request for a specific type of vehicle or a specific make or model of vehicle. The display of the guest interface 104 can provide a list or other indication of what vehicles are currently available to rent. When the customer completes the check-out process, the guest interface 104 can provide access to the selected rental vehicle's key.

In certain embodiments, the guest interface 104 can also facilitate the rental vehicle check-in process. The customer can sign into the system and notify the system that the vehicle is being returned. In some embodiments, the guest interface 104 provides a slot or a deposit door for the customer to place or insert the rental vehicle's key. Upon rental vehicle check-in, the guest interface 104 can display survey questions to the customer. The survey questions can be about the customer's experience with the rental company, the customer's opinions of the specific rental vehicle, or the customer's vehicle driving or buying habits. This information can be transmitted from the guest interface 104 to the rental recorder 102. The rental recorder 102 can aggregate this survey data. The information obtained from the check-in surveys can be valuable to the rental company or to vehicle manufacturers. For instance, the information gathered can assist an owner of a rental fleet on how to improve the rental vehicle or service. In another embodiment, the information gathered can be used to attempt to sell the customer a particular product, service, or vehicle.

In some embodiments, the rental recorder 102 includes a display to display a graphic or text. The display allows an employee to view any of the information or data contained within the rental recorder 102. For example, an employee can view the location of all the checked-out rental vehicles at any given time.

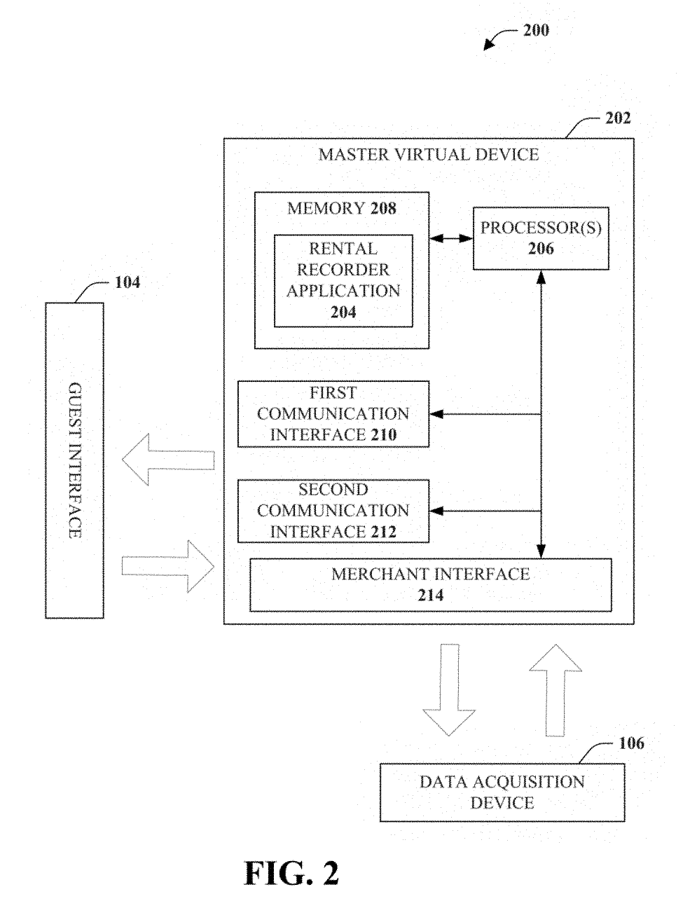

Turning to FIG. 2, a system 200 is illustrated utilizing the master virtual device 202 and the virtual rental recorder application 204 to process check in/check out information via the guest interface 104. Master virtual device 202 includes one or more processor(s) 206 configured to execute computer-executable instructions such as instructions composing virtual rental recorder application 204. Such computer-executable instructions can be stored on one or more computer-readable media including a non-transitory, computer-readable storage medium such as memory 208 of master virtual device 202.

Master virtual device 202 includes a first communication interface 210 and a second. communication interface 212. As shown in FIG. 2, first communication interface 210 can enable electronic communications between the master virtual device 202 and the guest interface 104. It is to be appreciated that the first communication interface 210 can be a wired or wireless interface including, but not limited, a LAN cable, an Ethernet cable, a USB interface, a serial interface, a WiFi interface, a short-range RF interface (Bluetooth), an infrared interface, a near-field communication (NFC) interface, etc. Second communication interface 212 can enable electronic communications between one or more data acquisition devices 106 and the master virtual device 202. As such, second communication interface 212 can be a WiFi interface, an Ethernet interface, a fiber optic interface, a cellular radio interface, a satellite interface, an interface for the Internet, etc. While shown separate in FIG. 2, first communication interface 210 and second communication interface 212 can be a single interface or an interface capable of simultaneous communication over multiple connections.

Master virtual device 202 can further include a merchant interface 214 that comprises various elements to obtain merchant input and to convey merchant output. For instance, merchant interface 214 can comprise a touch display which operates as both an input device and an output device. In addition, merchant interface 214 can also include various buttons, switches, keys, etc. by which a merchant can input information to master virtual device 202, and other displays, LED indicators, etc. by which other information can be output to the merchant.

In accordance with an embodiment, master virtual device 202 is a computing device, which can be hosted at a physical location or site of the guest interface 104, e.g. at a rental car facility. However, it is to be appreciated that the master virtual device 202 can be other portable form-factors such as a laptop computer, a convertible laptop, a cell phone, a PDA, a pocket computing device, a watch computing device, or the like. Moreover, it is to be appreciated that the functionality described herein with respect to the master virtual device 202 can be performed by a desktop computer, or other larger, less portable computing device such as a physical server. That is, rental recorder application 204 can be installed and executed on substantially any computing device provided that such a computing device can communicate with the guest interface 104 and the data acquisition devices 106 as described above with regard to FIG. 1.

It is to be appreciated that the master virtual device 202 and/or the rental recorder application 204 can be a network or a portion of a network, wherein the network is at least one of a website, a server, a computer, a cloud-service, a processor and memory, or a computing device connected to the Internet and connected to the guest interface 104. In general, the network can be coupled to one or more devices via wired or wireless connectivity in which data communications are enabled between the network and at least one of a second network, a subnetwork of the network, or a combination thereof. It is to be appreciated that any suitable number of networks can be used with the subject innovation and data communication on networks can be selected by one of sound engineering. judgment and/or one skilled in the art.

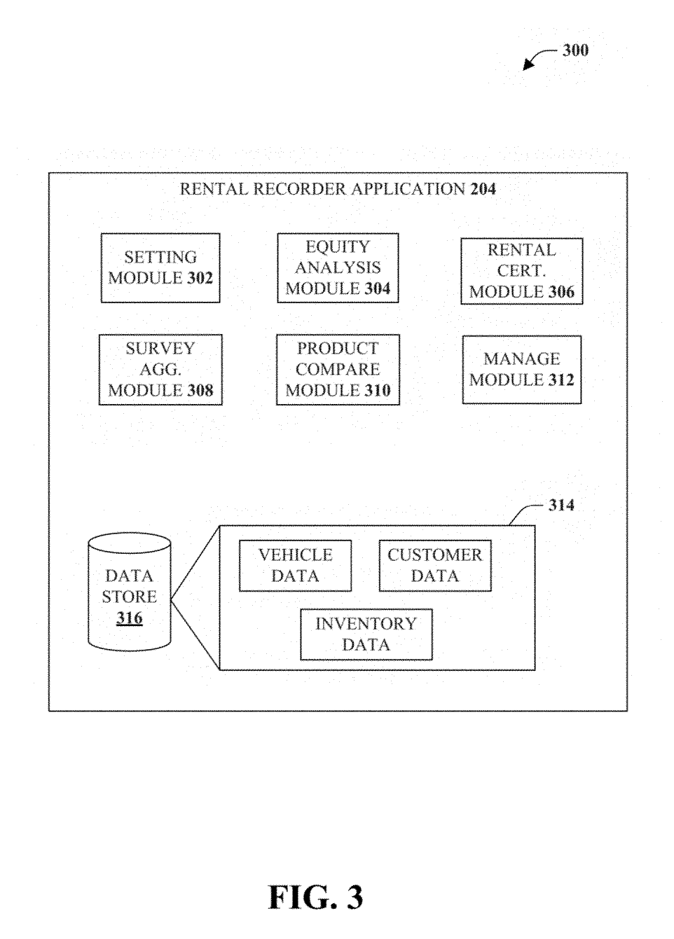

FIG. 3 illustrates a block diagram of an exemplary, non-limiting embodiment of the rental recorder application 204 according to one or more aspects. Rental recorder application 204 comprises computer-executable instructions and computer-readable data stored on memory 208 of the master virtual device 202. The computer-executable instructions of rental recorder application 204 are executable by processor 206 of master virtual device 202.

As shown in FIG. 3, the rental recorder application 204 can include one or more modules (e.g., settings module 302, equity analysis module 304, rental certification module 306, survey aggregation module 308, product comparison module 310, management module 312, among others) and data 314 stored on a data store 316 that stores data 314 (e.g., vehicle data, inventory data, customer data, among others). The one or more modules can include computer-executable instructions implementing various features, processes, operations, etc. of the rental recorder application 204.

Management module 312 provides administration functions, configuration of diagnostic applications, or the like. For example, management module 312 enables administration (e.g., retrieval, display, and editing) of customer profiles, and/or rental agreements. In addition, management module 312 enables configuration of payment information.

As shown in FIG. 3, the rental recorder application 204 includes various support data 314. Support data 314 includes vehicle data (e.g., vehicle miles driven, vehicle condition, vehicle availability, vehicle make/model/year, etc.), inventory data (e.g., available vehicles, number of available vehicles, etc.), customer data. (e.g., customer account information, user names, passwords, customer names, customer addresses/contact information, customer payment information, etc.), and the like.

The settings module 302 can be configured to provide data communications related to configuring a parameter related to the master virtual device 202 and/or the rental recorder application 204. In terms of the master virtual device 202, the settings component 302 can be used to configure communications settings between the master virtual device 202 and the guest interface 104. In another example, the settings module 302 can be utilized to configure communication settings between the master virtual device 202 and one or more data acquisition devices 106. For example, the settings module 302 can allow definition of the following parameters: number of data acquisition devices for connectivity to the master virtual device 202; credentials required for connectivity; security protocol definitions; data acquisition device requirements; authentication of user to rent a vehicle; notifications related to the rental of a vehicle; alerts related to an activity of renting a vehicle; and the like.

The equity analysis module 304 can be configured to run an equity analysis on an individual rental vehicle. For example, equity analysis module 304 can perform calculations to determine, using the data received from the vehicle's data acquisition device 106, the current market value of the rental vehicle if sold. The equity analysis module 304 can then compare this value with the calculated value of predicted profits from continuing to rent the vehicle. This information can be used to decide when to sell a used rental vehicle.

A rental certification module 306 can be configured to aggregate all of the data collected for the specific rental vehicle and include this information on a rental certification for that vehicle. This rental certification communicates to a potential buyer the type of driving performed and the conditions that the vehicle was driven in. The rental certification can effectively increase the value of a rental vehicle being sold if the certification contains information showing responsible, or light driving. On the other hand, the rental certification can decrease the value of a rental vehicle being sold if the certification contains information showing severe or rough driving.

Upon rental vehicle check-in, the guest interface 104 can display survey questions to the customer. The survey questions can be about the customer's experience with the rental company, the customer's opinions of the specific rental vehicle, or the customer's vehicle driving or buying habits. This information can be transmitted from the guest interface 104 to the master virtual device 202. A survey aggregation module 308 can be configured to aggregate this survey data.

A product comparison module 310 can be configured to store data regarding the brand or model of products installed on the rental vehicles. For example, the product comparison module 310 can keep track of brands or models of tires, oil, or any auto part used on each rental vehicle. This information can be used along with vehicle performance data to analyze and compare the performance of different brands and models of equipment or auto parts.

Although a single data store 316 is illustrated, any suitable number of data stores can be used with the system 100. The number of data stores and the organization where the data is stored there on can be selected with sound engineering judgment and/or by one skilled in the art without departing from the scope of the subject innovation.

It is to be appreciated that any component or module from the rental recorder application 204 can be a stand-alone component module, a sub-component, a sub-module, an integrated component with another component, an integrated module within another module, a system, a portion of a system described herein and/or a combination thereof. Thus, the functionality described for the rental recorder application 204 can be performed by any number of the components or modules discussed.

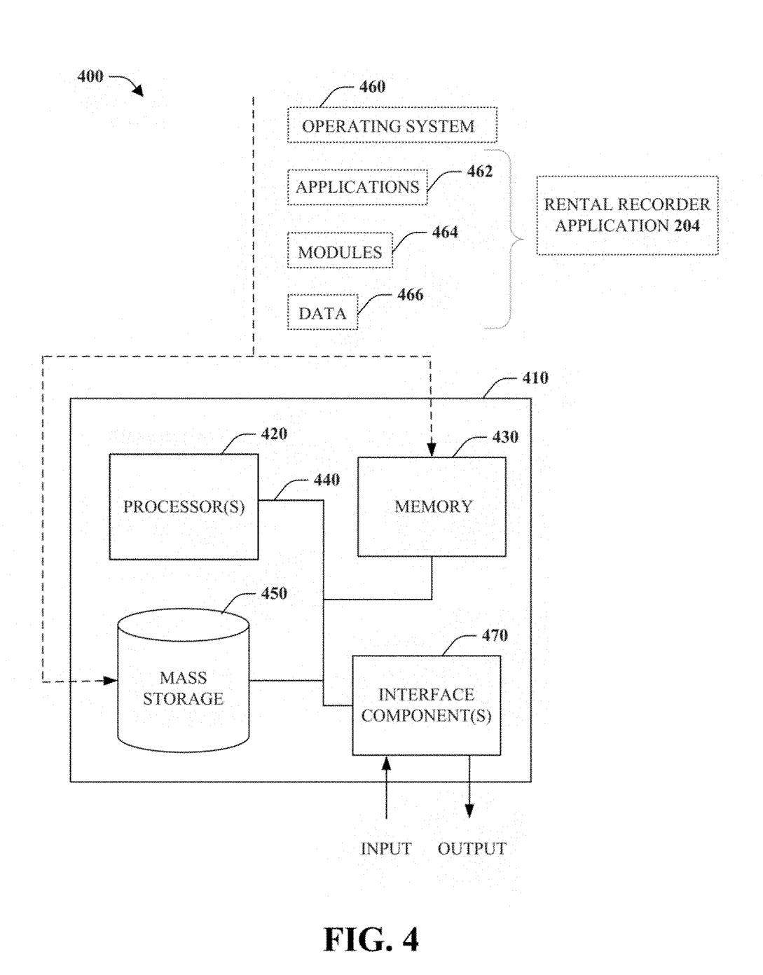

In order to provide a context for the claimed subject matter, FIG. 4 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can. be practiced with various computer system configurations, including single-processor, multi-processor or multi-core processor computer systems, mini-computing devices, mainframe computers, as well as personal computers, hand-held computing devices (e.g., personal digital assistant (PDA), portable gaming device, smartphone, tablet, Wi-Fi device, laptop, phone, among others), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 4, illustrated is an example general-purpose computer 410 or computing device e.g., desktop, laptop, server, hand-held, programmable consumer or industrial electronics, set-top box, game system . . . ). The computer 410 includes one or more processor(s) 420, memory 430, system bus 440, mass storage 450, and one or more interface components 470. The system bus 440 communicatively couples at least the above system components. However, it is to be appreciated that in its simplest form the computer 410 can include one or more processors 420 coupled to memory 430 that execute various computer executable actions, instructions, and or components stored in memory 430.

The processor(s) 420 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 420 may also be implemented as a combination of computing devices; for example, a combination of a DSP and a microprocessor, a plurality of microprocessors, multi-core processors, one or more microprocessors in conjunction with a DSP core, or any other such configuration.

The computer 410 can include or otherwise interact with a variety of computer-readable media to facilitate control of the computer 410 to implement one or more aspects of the claimed subject matter. The computer-readable media can be any available media that can be accessed by the computer 410 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD). . . ), and solid state devices (e.g., solid state drive (SSD), flash memory drive (e.g., card, stick, key drive . . . ) . . . ), or any other medium which can be used to store the desired information and which can be accessed by the computer 410.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 430 and mass storage 450 are examples of computer-readable storage media. Depending on the exact configuration and type of computing device, memory 430 may be volatile (e.g., RAM), non-volatile (e.g., ROM, flash memory . . . ) or some combination of the two. By way of example, the basic input/output system (BIOS), including basic routines to transfer information between elements within the computer 410, such as during start-up, can be stored in nonvolatile memory, while volatile memory can act as external cache memory to facilitate processing by the processor(s) 420, among other things.

Mass storage 450 includes removable/non-removable, volatile non-volatile computer storage media for storage of large amounts of data relative to the memory 1030. For example, mass storage 450 includes, but is not limited to, one or more devices such as a magnetic or optical disk drive, floppy disk drive, flash memory, solid-state drive, or memory stick.

Memory 430 and mass storage 450 can include, or have stored therein, operating system 460, one or more applications 462, one or more program modules 464, and data 466. The operating system 460 acts to control and allocate resources of the computer 410. Applications 462 include one or both of system and application software and can exploit management of resources by the operating system 460 through program modules 464 and data 466 stored in memory 430 and/or mass storage 450 to perform one or more actions. Accordingly, applications 462 can tam a general-purpose computer 410 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the rental recorder application 204 (associated functionality, modules, and/or portions thereof) can be, or form part, of an application 462, and include one or more modules 464 and data 466 stored in memory and/or mass storage 450 whose functionality can be realized when executed by one or more processor(s) 420. Moreover, it is to be appreciated that the software, firmware, or combination thereof to perform the functionality of the described components herein can be downloaded, installed, or a combination thereof from any host. For instance, the host can be an online store, a website, an IP address, an application store, a network, a storage medium, a portable hard disk, a server, or the Internet.

In accordance with one particular embodiment, the processor(s) 420 can correspond to a system on a chip (SOC) or like architecture including, or in other words integrating, both hardware and software on a single integrated circuit substrate. Here, the processor(s) 420 can include one or more processors as well as memory at least similar to processor(s) 420 and memory 430, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the rental recorder application 204 (associated functionality, modules, and/or portions thereof) can be embedded within hardware in a SOC architecture.

The computer 410 also includes one or more interface components 470 that are communicatively coupled to the system bus 440 and facilitate interaction with the computer 410. By way of example, the interface component 470 can be a port (e.g., serial, parallel, PCMCIA, USB, FireWire . . . ) or an interface card (e.g., sound, video . . . ) or the like. In one example implementation, the interface component 470 can be embodied as a user input/output interface to enable a user to enter commands and information into the computer 410 through one or more input devices (e.g., pointing device such as a mouse, trackball, stylus, touch pad, keyboard, microphone, joystick, game pad, satellite dish scanner, camera, other computer . . . ). In another example implementation, the interface component 470 can be embodied as an output peripheral interface to supply output to displays (e.g., CRT, LCD plasma . . . ), speakers, printers, and/or other computers, among other things. Still further yet, the interface component 470 can be embodied as a network interface to enable communication with other computing devices (not shown), such as over a wired or wireless communications link.

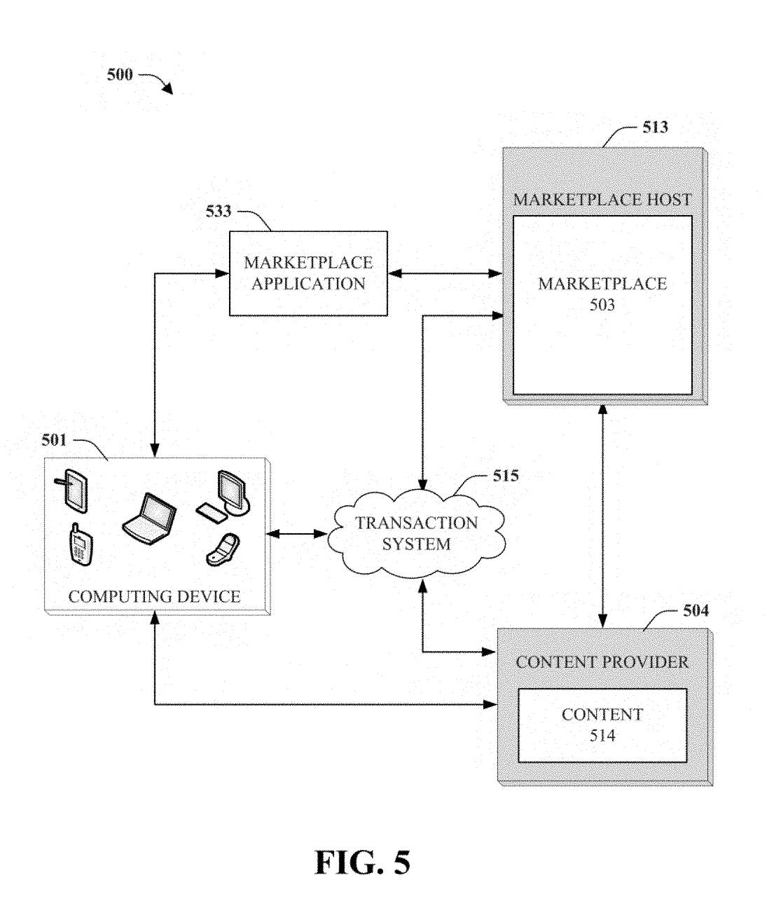

FIG. 5 illustrates an operating environment 500 that can be used with the subject innovation and in particular, the rental recorder application 204. The operating environment 500 includes a computing device 501 (e.g., device smartphone, a tablet, a laptop, a desktop machine, a portable gaming device, a device with Internet connectivity, among others), a user, a marketplace 503, a content provider 504, and content 514. The operating environment 500 is configured to deliver data (e.g., content 514) to the computing device 501 based upon a request from the computing device 501 (e.g., typically initiated by a user of the computing device 501). However, it may be appreciated that the delivery of data to the computing device 501 can be pushed to the computing device 501 and further approved (e.g., acceptance of license agreement, among others) by the user. The data delivered can be from a content provider 504, wherein the data can be delivered directly to the computing device 501 or indirectly delivered to the computing device 501 via the marketplace 503 and/or the marketplace applications 533. In an embodiment, the computing device 501 can utilize a transaction system 515 that facilitates purchasing data via at least one of the marketplace 503, the marketplace applications 533, the content provider 504, and the like. The transaction system. 515 can be configured to utilize a charging gateway to facilitate completing a transaction between entities (e.g., user content provider, marketplace, among others).

The computing device 501 and the marketplace 503 can be configured to communicate across a network, for example, wherein the marketplace 503 is accessed via the marketplace application 533 or a user intern face (UI) associated with one of the marketplace 503 or the marketplace host 513. The marketplace 503 can be hosted by a marketplace host 513 associated with any suitable host, server, computer, data store, and the like.

In one embodiment, the computing device 501 is mobile so that it may function for a period of time without requiring a physical connection to a power source or network provider. For example, a cellular network or a Wi-Fi connection can be used by the computing device 501 in order to transmit and/or receive data within the operating environment 500.

A user can employ the computing device 501 for the device's intended functions as well as communicating data with the marketplace 503 and/or marketplace host 513. Commonly, the user purchases content 514 and/or products from the content provider 504 via the transaction system 515. It is to be appreciated that the marketplace 503 can be in an electronic form such as a website, the marketplace application 533, or an executable program. In a preferred embodiment, the marketplace 503 takes the form of the marketplace application 533 configured to run on the user's computing device 501. The marketplace application 533 may be utilized to install the content 514 from the content provider 504 onto the computing device 501.

The marketplace 503 can further connect the content provider 504 and/or the content 514 of the content provider 504 with the computing device 501 to allow the user to receive content 514 via a download (e.g., communication of data packets). The marketplace 503 can offer the user a variety of content 514 for purchase (via the transaction system 515) or for free of charge. The content 514 offered by the marketplace 503 may also come from the marketplace host 513. For example, the content provider 504 can have a website for direct delivery of content 514 or have content 514 hosted in the marketplace 503 by the marketplace host 513. Thus, in such an example, a user can directly receive data or content from the website of the content provider 504 or use the marketplace application 533 to identify the content 514 for receipt through the marketplace 503. Moreover, the content 514 can be tailored to the computing device 501. For instance, a first content can be built for a first computing device having a first operating system and a second content can be built for a second computing device having a second operating system, wherein the first content and the second content can be from the content provider 504.

In some embodiments, the system 500 utilizes the transaction system 515. The transaction system 515 can include a transaction gateway that facilitates transactions between at least the marketplace host 513, one or more users, the marketplace 503, and/or the content provider 504. When the user purchases content 514 from the marketplace 503 or content provider 504, a charging gateway can receive a request to apply a charge to a user account (e.g., a monetary value via an electronic transaction via au account) owned or authorized by the user. For example, the user account can be, but is not limited to being, a credit card account, an account with the content provider 504 or marketplace host 513, a bank account, a debit account, an e-commerce account (e.g. Pay-Pal®), an electronic account, a savings account, and the like.

The transaction gateway can store transaction data (e.g., user account, username, password, data related to the user, data related to the computing device 501, among others) specific to a transaction to receive content 514. The transaction gateway can further collect and/or store data regarding one or more users, wherein the data can be, but is not limited to, credit card numbers, to make it easier for the one or more users to engage in multiple transactions (e.g., simultaneously and/or various points in time). The transaction gateway can further reverse a transaction between one or more parties involved, such as providing a refund to the user.

It is to be appreciated that a purchase may not require the transfer of finances. For example, the content 514 on the marketplace 503 could be free to download. Additionally, a portion of the transaction system 515 can be integrated into at least one of the content provider 504, the marketplace host 513, the marketplace application 533, or a combination thereof in another embodiment, the first content 514 can be free but additional content related to the first content 514 can require a purchase.

The content provider 504 can create content 514 (e.g., also referred to as products. software, apps, applications, and the like) that can be sold on the marketplace 503. By way of example and not limitation, the content provider 504 can be a videogame company that creates a game to be made available for download from the marketplace 503. By way of another example and not limitation, a bank can develop a mobile banking application that is communicated to the marketplace 503 and made available for download via the marketplace 503. In such an example, the bank is the content provider 504. Additionally, the bank may host the mobile banking application on the bank's website for download or delivery to users. It is to be appreciated and understood that the content provider 504 is not limited to these examples and the content provider 504 can be any suitable entity (e.g., user, company, business, group of users, and the like) that creates or develops content 514 to be distributed to the marketplace host 513 for download via the marketplace 503.

The marketplace host 513 maintains the marketplace 503 on a network. The marketplace host 513 owns and/or controls a host server that contains the marketplace 503, and provides the user access to the marketplace 503. The marketplace host 513 can further control an amount of bandwidth allocated to the user to download the content 514 of the one or more content providers 504. In a non-limiting embodiment, the marketplace host 513 can own and/or control the marketplace 503. In another non-limiting embodiment, the marketplace host 513 can host the marketplace 503 on a network to enable access by the user.

in an exemplary embodiment, a user accesses the marketplace 503 via the marketplace application 533 located on the computing device 501. The computing device 501 can have access to the network 505, and the computing device 501 can communicate data in the form of a query to the marketplace host 513, wherein the data can be a request for information on content 514. The marketplace host 513 can communicate data in the form of a query result (which can include content 514) via a network to the computing device 501 for review, install, use, storage, and the like. In a non-limiting embodiment, the computing device 501 can include a user-interface that displays the data (e.g., the query, the query result, the content 514, among others) for the user.

Prior to download of content 514, the user can further navigate information regarding the content 514 that is displayed and select to either request additional content 514 or to purchase the content 514. If the user selects to purchase content 514, the marketplace application 533 communicates a purchase request to the marketplace host 513. The marketplace host 513 can then use the transaction system 515 which includes the transaction gateway charging the user account if data related to the user account is available, and if the user account is not available, then the marketplace host 513 can request user account 512 information from the user which can then be sent to the transaction gateway. Upon receipt of the user account information, the transaction gateway can charge the user account, and send confirmation of the transaction back to the marketplace host 513.

The marketplace host 513 can then communicate the confirmation information to the computing device 501, as well as enable the user to download data for the content 514 and/or the marketplace application 533 stored in a host server regarding the specific content 514 and/or marketplace application 533 purchased. The marketplace application 533 can further assist with installation of the content 514 or marketplace application 533 purchased onto the computing device 501. It is to be appreciated and understood that the above process can occur in any order, such as a downloading of application information from the marketplace host 513 prior to the transaction and the order of the above described process is not to be limiting on the subject innovation.

One of ordinary skill in the art can appreciate that the various embodiments of a subscription-based diagnostic software service described herein can be implemented in connection with any computing device, client device, or server device, which can be deployed as part of a computer network or in a distributed computing environment such as the cloud. The various embodiments described herein can be implemented in substantially any computer system or computing environment having any number of memory or storage units, any number of processing units, and any number of applications and processes occurring across any number of storage units and processing units. This includes, but is not hunted to, cloud environments with physical computing devices (e.g., servers) aggregating computing resources (i.e., memory, persistent storage, processor cycles, network bandwidth, etc.) which are distributed among a plurality of computable objects. The physical computing devices can intercommunicate via a variety of physical communication links such as wired communication media (e.g., fiber optics, twisted pair wires, coaxial cables, etc.) and/or wireless communication media (e.g., microwave, satellite, cellular, radio or spread spectrum, free-space optical, etc.). The physical computing devices can be aggregated and exposed according to various levels of abstraction for use by application or service providers, to provide computing services or functionality to client computing devices. The client computing devices can access the computing services or functionality via application program interfaces (APIs), web browsers, or other standalone or networked applications. Accordingly, aspects of the subscription-based diagnostic software service can be implemented based on such a cloud environment. For example, the rental recorder application 202 can reside in the cloud environment such that the computer-executable instruction implementing the functionality thereof are executed with the aggregated computing resources provided by the plurality of physical computing devices. The cloud environment provides one or more methods of access to the subject innovation, which are utilized the rental recorder application 202. In an embodiment, software and/or a component can be installed on a mobile device to allow data communication between the mobile device and the cloud environment. These methods of access include IP addresses, domain names, URLs, etc. Since the aggregated computing resources can be provided by physical computing device remotely located from one another, the cloud environment can include additional devices such as a routers, load balancers, switches, etc., that appropriately coordinate network data.

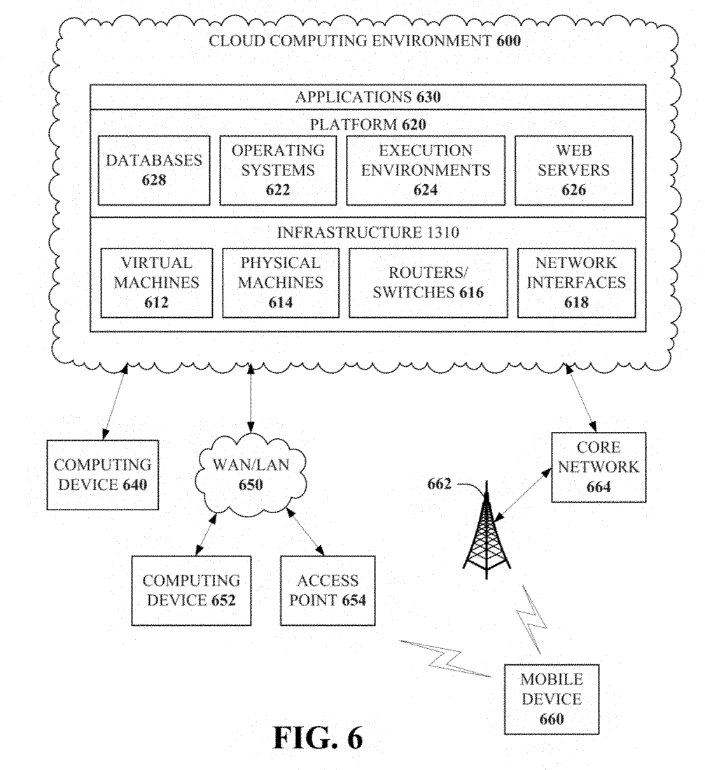

FIG. 6 provides a schematic diagram of an exemplary networked or distributed computing environment, such as a cloud computing environment 600. The cloud computing environment 600 represents a collection of computing resources available, typically via the Internet, to one or more client devices. The cloud computing environment 600 comprises various levels of abstraction: infrastructure 610, a platform 620, and applications 630. Each level, from infrastructure 610 to applications 630 is generally implemented on top of lower levels, with infrastructure 610 representing the lowest level.

Infrastructure 610 generally encompasses the physical resources and components on which cloud services are deployed. For instance, infrastructure 610 can include virtual machines 612, physical machines 614, routers switches 616, and network interfaces 618. The network interfaces 618 provide access to the cloud computing environment 600, via the Internet or other network, from client devices such as computing devices 640, 652, 660, etc. That is, network interfaces 618 provide an outermost boundary of cloud computing environment 600 and can couple the cloud computing environment 600 to other networks, the Internet, and client computing devices. Routers/switches 616 couple the network interfaces 618 to physical machines 614, which are computing devices comprising computer processors, memory, mass storage devices, etc. Hardware of physical machines 614 can be virtual. zed to provide virtual machines 612. In an aspect, virtual machines 612 can be executed on one or more physical machines 614. That is, one physical machine 614 can include a plurality of virtual machines 612.

Implemented on infrastructure 610, platform 620 includes software that forming a foundation for applications 630. The software forming platform 620 includes operating systems 622, programming or execution environments 624, web servers 626, and databases 628. The software of platform 620 can be installed on virtual machines 612 and/or physical machines 614.

Applications 630 include user-facing software applications, implemented on platform 620, that provide services to various client devices. In this regard, at least the rental recorder application 204 as described herein is an example application 630. As illustrated in FIG. 6, client devices can include computing devices 640, 652 and mobile device 660. Computing devices 640, 652 can be directly coupled to the Internet, and therefore the cloud computing environment 600, or indirectly coupled to the Internet via a WAN/LAN 650. The WAN/LAN 650 can include an access point 654 that enables wireless communications (e.g., WiFi) with mobile device 660. In this regard, via access point 654 and WAN/LAN 650, mobile device 660 can communicate wirelessly with the cloud computing environment 600. Mobile device 660 can also wirelessly communicate according to cellular technology such as, but not limited to, GSM, LTE, WiMAX, HSPA, etc. Accordingly, mobile device 660 can wireless communicate with a base station 662, which is coupled to a core network 664 of a wireless communication provider. The core network 664 includes a gateway to the Internet and, via the Internet, provides a communication path to the cloud computing environment 600.

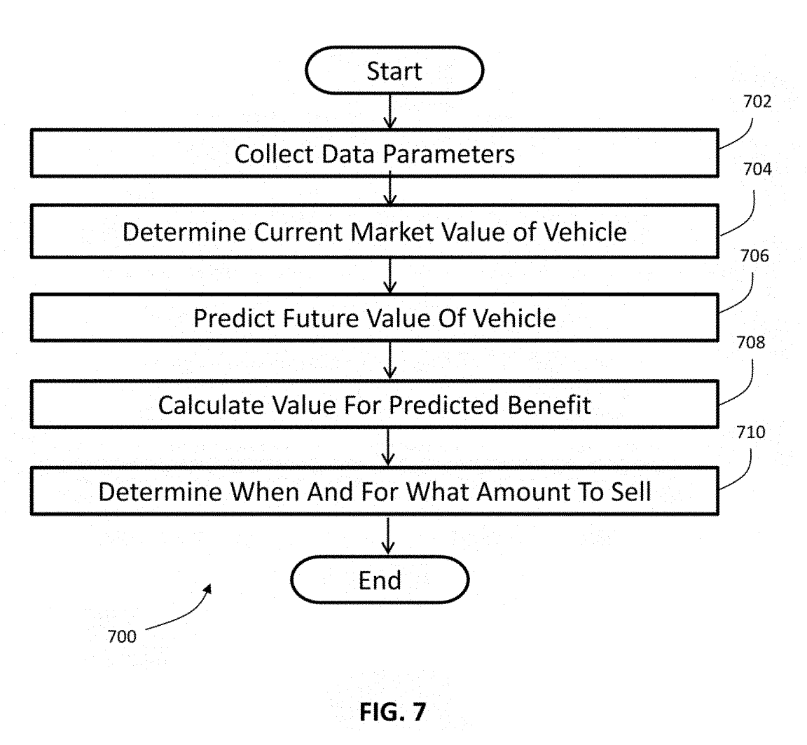

FIG. 7 is a flow chart illustrating an example method 700 for analyzing vehicle data. At step 702, a computer collects one or more data parameters associated with the vehicle. At step 704, the computer analyzes the collected data parameters associated with the vehicle to determine a current market value of the vehicle. At step 706, the computer extrapolates the collected data parameters to predict a value of the vehicle at a future time. At step 708, the computer calculates a value for predicted profits generated from continuing to rent the vehicle until the future time. At step 710, the computer determines when and for what amount to sell the rental vehicle, based on the determined current market value of the vehicle, the predicted market value of the vehicle, and the calculated predicted profits from continuing to rent the vehicle.

In the specification and claims, reference will be made to a number of terms that have the following meanings. The singular firms “a”, “an.” and “the” include plural referents unless the context clearly dictates otherwise. Approximating language, as used herein throughout the specification and claims, may be applied to modify a quantitative representation that could. permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur this distinction is captured by the terms “may” and “may be.”

This written description uses examples to disclose the invention, including the best mode, and also to enable one of ordinary skill in the art to practice the invention, including making and using, a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A system for analyzing vehicle data to determine a time to sell a rental vehicle, comprising:
a data acquisition device configured to interface with a vehicle and to collect one or more data parameters associated with the vehicle; and
a data analysis device comprising a processor, a communication interface for interfacing with. the data acquisition device, a computer tangible storage device, and program instructions stored on the storage device for execution by the processor, the program instructions comprising:
first program instructions for analyzing the collected data parameters associated with the vehicle to determine a current market value of the vehicle;
second program instructions for extrapolating the collected data parameters to predict a depreciated value of the vehicle at a future time;
third program instructions for calculating a value for predicted benefit resulting from continuing to loan the vehicle until the future time; and
fourth program instructions for determining when and for what amount to sell the rental vehicle, based on the determined current market value of the vehicle, the predicted market value of the vehicle, and the calculated predicted profits from continuing to rent the vehicle.

2. The system of claim 1, wherein the first program instructions calculate the current market value by retrieving a predetermined base value associated with a vehicle given a year, make, and model, and adjusting, the predetermined value based on predetermined adjustment factors associated with collected data parameters.

3. The system of claim 1, wherein the program instructions further comprise fifth program instructions to generate a rental certification for the vehicle, based on the collected data parameters, thereby providing a buyer of the vehicle with a report of the vehicles driving history while the vehicle was being rented.

4. The system of claim 1, wherein collected data parameters comprises at least one of rate of acceleration, rate of deceleration, and fuel consumption.

5. The system of claim 1, wherein collected data parameters comprises GPS location of the vehicle, thereby enabling identification of a vehicle location.

6. The system of claim 1, wherein the program instructions further comprise sixth program instructions to receive data representative of brands of products used on the vehicle and to analyze performance of the vehicle with respect to the particular brands of products, based on the collected data parameters.

7. The system of claim 1 wherein products analyzed comprise at least one of oil and tires.

8. The system of claim 1, wherein the program instructions further comprise seventh program instructions to receive survey data from rental customers of the rental vehicle indicative of the rental customer's experience with the rental vehicle, and to analyze the survey data to determine what a customer values, thereby enabling future improvements to one of the vehicle, sales or service associated with the vehicle.

9. The system of claim 1, wherein the data acquisition device is configured to interface with the rental vehicle's onboard diagnostic port.

10. The system of claim 1, wherein the communication interface for interfacing with the data acquisition device is configured to wirelessly interface with the data acquisition device.

11. A method for analyzing vehicle data to determine a tine to sell a rental vehicle, the method comprising the steps of:
a computer collecting one or more data parameters associated with the vehicle:
the computer analyzing the collected data parameters associated with the vehicle to determine a current market value of the vehicle;
the computer extrapolating the collected data parameters to predict a depreciated value of the vehicle at a future time;
the computer calculating a value for predicted benefit resulting from continuing to loan the vehicle until the future time; and
the computer determining when and for what amount to sell the rental vehicle, based on the determined current market value of the vehicle, the predicted market value of the vehicle, and the calculated predicted profits from continuing to rent the vehicle.

12. The method of claim 11, wherein the step of calculating the current market value comprises retrieving a predetermined base value associated with a vehicle given a year, make, and model, and adjusting the predetermined value based on predetermined adjustment factors associated with collected data parameters.

13. The method of claim 11, further comprising the step of generating a rental certification for the vehicle, based on the collected data parameters, thereby providing a buyer of the vehicle with a report of the vehicles driving history while the vehicle was being rented.

14. The method of claim. 11, further comprising the step of receiving data representative of brands of products used on the vehicle and analyzing performance of the vehicle with respect to the particular brands of products, based on the collected data parameters.

15. The method of claim 11, further comprising the step of receiving survey data from rental customers of the rental vehicle indicative of the rental customer's experience with the rental vehicle, and analyzing the survey data to determine what products or services to offer for sale to the rental customer based on the rental customer's experience.

16. A computer program product for analyzing vehicle data to determine a time to sell a rental vehicle, the computer program product comprising one or more computer-readable tangible storage devices, and program instructions stored on at least one of the one or more storage devices, the program instructions comprising:
first program instructions for collecting one or more data parameters associated with the vehicle;
second program instructions for analyzing the collected data parameters associated with the vehicle to determine a current market value of the vehicle;
third program instructions for extrapolating the collected data parameters o predict a depreciated value of the vehicle at a future time;
fourth program instructions for calculating a value for predicted benefit resulting from continuing to loan the vehicle until the future time; and
fifth program instructions for determining when and for what amount to sell the rental. vehicle, based on the determined current market value of the vehicle, the predicted market value of the vehicle, and the calculated predicted profits from continuing to rent the vehicle.

17. The computer program product of claim 16, wherein the second program instructions calculate the current market value by retrieving a predetermined base value associated with a vehicle given a year, make, and model, and adjusting the predetermined value based on predetermined adjustment factors associated with collected data parameters.

18. The computer program product of claim 16, wherein the program instructions further comprise sixth program instructions to generate a rental certification for the vehicle, based on the collected data parameters, thereby providing a buyer of the vehicle with a report of the vehicles driving history while the vehicle was being rented.

19. The computer program product of claim 16, wherein the program instructions further comprise seventh program instructions to receive data representative of brands of products used on the vehicle and to analyze performance of the vehicle with respect to the particular brands of products, based on the collected data parameters.

20. The computer program product of claim 16, wherein the program instructions further comprise eighth program instructions to receive survey data from rental customers of the rental vehicle indicative of the rental customer's experience with the rental vehicle, and to analyze the survey data to determine what products or services to offer for sale to the rental customer based on the rental customer's experience.

21. The computer program product of claim 16, wherein the first program instructions are configured to collect the one or more data parameters by communication with the vehicle's onboard diagnostic port.
